(19) United States
(12) Patent Application Publication
(10) Pub. No.: US 2004/0103317 A1
(43) Pub. Date: May 27, 2004

(54) Method and apparatus for protecting secure credentials on an untrusted computer platform

(76) Inventor: William D. Burns, Campbell, CA (US)

Correspondence Address: GLENN PATENT GROUP, 3475 EDISON WAY, SUITE L, MENLO PARK, CA, 94025, US

(21) Appl. No.: 10/383,708

(22) Filed: Mar. 6, 2003

Related U.S. Application Data
(60) Provisional application No. 60/428,601, filed on Nov. 22, 2002.

(51) Int. Cl. G06F 11/30

(52) U.S. Cl. 713/201

(57) ABSTRACT

The invention comprises a technique in which a desired computer security policy, e.g. member or corporate security policy, can be enforced by performing a host computer security assessment at the time of user authentication by means of a system configuration that comprises a managed and trusted device. In this way, a company can extend their corporate security policy to the user's desktop and verify an untrusted host, e.g. a PC, by means of a trustworthy technology, e.g. a hardened smartcard. Because the smartcard is relatively tamperproof, operations performed on the card are considered more trustworthy than those running solely on the PC. The smartcard and associated middleware running on the host perform such security-related functions as, for example, verifying that the host's anti-virus software is running and that it is not modified, verifying that the anti-virus software has the most recent virus definitions installed, verifying that the host is not currently infected and does not have dangerous and/or unpermitted remote control Trojan horses running and listening on TCP/IP ports, and checking that the host has a password-protected screen saver enabled to prevent unauthorized access to the system in the user's absence.

### CROSS-REFERENCE TO RELATED APPLICATIONS

This application claims priority to U.S. Provisional Patent Application No. 60/428,601 filed Nov. 22, 2002.

### BACKGROUND OF THE INVENTION

1. Technical Field

The invention relates to enforcing computer and enterprise security policies. More particularly, the invention relates to protecting secure credentials on an untrusted computer platform.

2. Description of the Prior Art

Corporations and Internet service providers spend millions of dollars purchasing and deploying security software, such as anti-virus packages and firewalls, to enforce security policies that are intended to protect both their systems and those of individuals who use such systems. Typically, it is left up to the individual user's to activate and maintain these security elements for their use at their desktop, i.e. the user's point of authentication. Many times these systems are deactivated or not kept current by such users. Unfortunately, there is no apparent or immediate negative impact visible to the user as a result of having these defenses shut down or crippled. Such damage as may occur only becomes apparent after system security is breached. Addressing this problem once the harm is done is akin to shutting the barn door after the livestock have all escaped. Thus, this lack of defensive measures clearly puts the corporation's and/or user's personal information at risk.

It would be advantageous to provide a technique for enforcing a desired computer security policy at a point of user authentication.

### SUMMARY OF THE INVENTION

A technique is provided for enforcing a desired computer security policy at a point of user authentication. The invention comprises a technique in which a desired computer security policy, e.g. member or corporate policy, can be enforced by performing a host computer security assessment at the time of user authentication by means of a system configuration that comprises a managed and trusted device. In this way, a company can extend their corporate security policy to the user's desktop and verify an untrusted host, e.g. a PC, by means of a trustworthy technology, e.g. a hardened smartcard. Because the smartcard is relatively tamperproof, operations performed on the card are considered more trustworthy than those running solely on the PC. The smartcard and associated middleware running on the host perform such security-related functions as, for example, verifying that the host's anti-virus software is running and that it is not modified, verifying that the anti-virus software has the most recent virus definitions installed, verifying that the host is not currently infected and does not have dangerous and/or unpermitted remote control Trojan horses running and listening on TCP/IP ports, and checking that the host has a password-protected screen saver enabled to prevent unauthorized access to the system in the user's absence.

### BRIEF DESCRIPTION OF THE DRAWINGS

FIG. 1 is a block schematic diagram of an apparatus for protecting secure credentials on an untrusted computer platform according to the invention; and

FIG. 2 is a flow diagram of a method for protecting secure credentials on an untrusted computer platform according to the invention.

### DETAILED DESCRIPTION OF THE INVENTION

A technique is provided for enforcing a desired computer security policy at a point of user authentication. The presently preferred embodiment of the invention accomplishes this by performing a security assessment based on a pre-determined and configurable security policy stored on a trusted computing device. If the assessment of the host is consistent with the security policy, the user is permitted to continue the authentication process. If the assessment of the host fails to meet the security policy stored or evaluated on the trusted computing device, authentication is not allowed to proceed and the user is instructed on how to fix the problem or who to contact.

The security policy may implement such policy rules as detecting whether anti-virus software is running, whether the anti-virus definition file is up to date, whether there are known viruses or potentially harmful applications running on the host, whether a password-protected screen saver is configured to activate on the host in a specified duration of inactivity and thereby prevent unauthorized system access during a user's absence from his workstation, and anything else that is decided to be relevant to protect system access at this point.

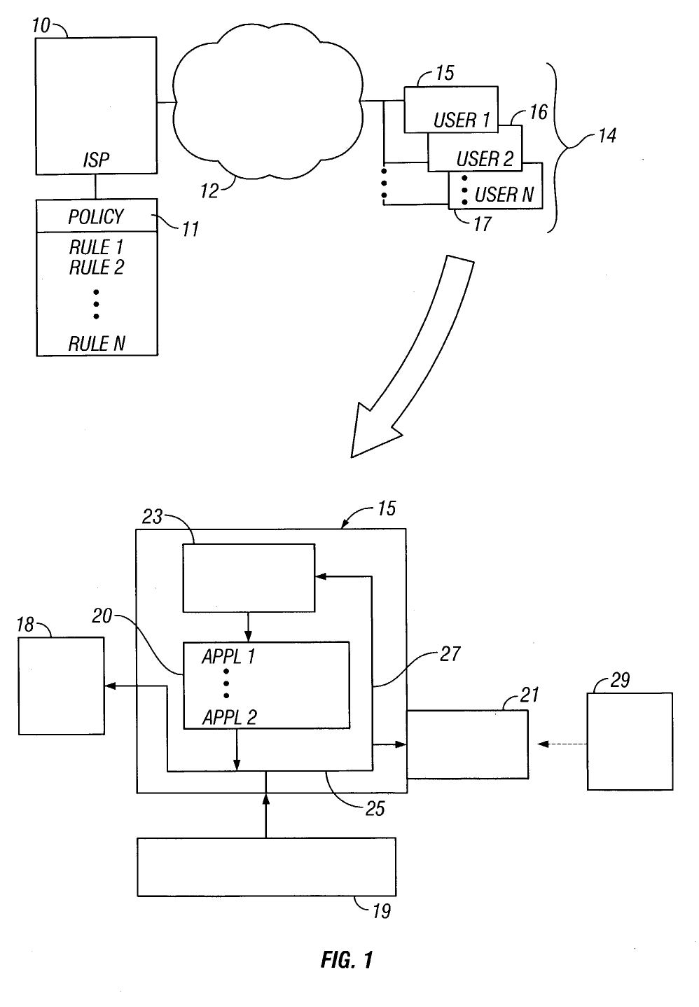

FIG. 1 is a block schematic diagram of an apparatus for protecting secure credentials on an untrusted computer platform according to the invention. In this embodiment of the invention, an Internet service provider, such as America On Line, ISP 10, implements a security policy 11, which comprises a set of security rules Rule 1-Rule N. Some of these rules apply to the ISP internal systems and some of them are to be applied by the herein described invention in connection with users who have access to the ISP. Such users communicate with the ISP via an electronic network 12, such as the Internet, and comprise, collectively a group 14 made up of those individual users who have access to the ISP, e.g. User 1-User N 15, 16, 17.

Each user enjoys such access to the ISP via a computer, for example the computer 15 shown on FIG. 1, which in its basic configuration comprises a monitor or other display device 18 and a keyboard or other user input device 19. Those skilled in the art will appreciate that the invention is intended for all types of user access, including via a conventional PC, as well as via various handheld and other devices. Accordingly, the display device may comprise, as well, such devices as an LCD or plasma display, tactile device, or aural device. Further, the input device may comprise a touch screen, mouse, tablet, pen system, and the like.

Each user computer further includes storage that contains various user applications APPL 1-APPL N 20, such as those for word processing and communications, as well as authentication applications.

In the preferred embodiment, the security policy elements are codified and stored in a protected portion of a trusted computing device 21, such as a smartcard, and are updated frequently by a remote host 29 maintained by a corporation or Internet service provider. Those skilled in the art will appreciate that the example of a smartcard herein is only one manner in which a trusted computing device may be provided. It is contemplated that many other known tamperproof mechanisms may be applied to the invention to establish a requisite level of trust at the user's computer, as would be know to those skilled in the art. For example, the user may possess a tamperproof device that incorporates a transmitter, such that the user's proximity to his computer is sufficient to establish the requisite trust, based upon a secure conversation between the device and the computer. When the user is not near to his computer, such secure conversation would cease, and such trust would be absent.

The trusted computing device also contains the user's credentials that are used to authenticate the user to an application on the host or a remote system. The user must provide a passcode or PIN to use these credentials stored on the trusted computing device. Applications that require these credentials may include or use a module 23 that allows them to read or use these credentials. Such functionality may also be an integral part of the application or computer operating system, or it may be provided by a separate application that is run on the user's computer, or that is itself embedded into a secure hardware element, such as a memory embedded in a “dongle,” i.e. a device that is adapted for connection to one of the user's computer ports, such as the USB or Firewire port.

The module intercepts authentication requests (as shown by the arrows bearing the numeric designations 25 and 27 in FIG. 1) and performs the role of interpreting the security policy stored on the trusted computing device and performing the assessment. It does this before the user is allowed to enter their passcode to unlock the trusted computing device, thereby protecting the user from divulging their passcode to an unscrupulous application. If the module determines that the host computer is in compliance with the security policy reflected on the trusted computing device, the application is permitted to prompt the user for their passcode. When the correct passcode is provided, the application is also able to authenticate the user and the user is allowed to complete their desired task. If the module determines that the host is not in compliance with one or more elements in the security policy, it refuses the application permission to prompt the user for the user's passcode, which therefore denies the user access to the application.

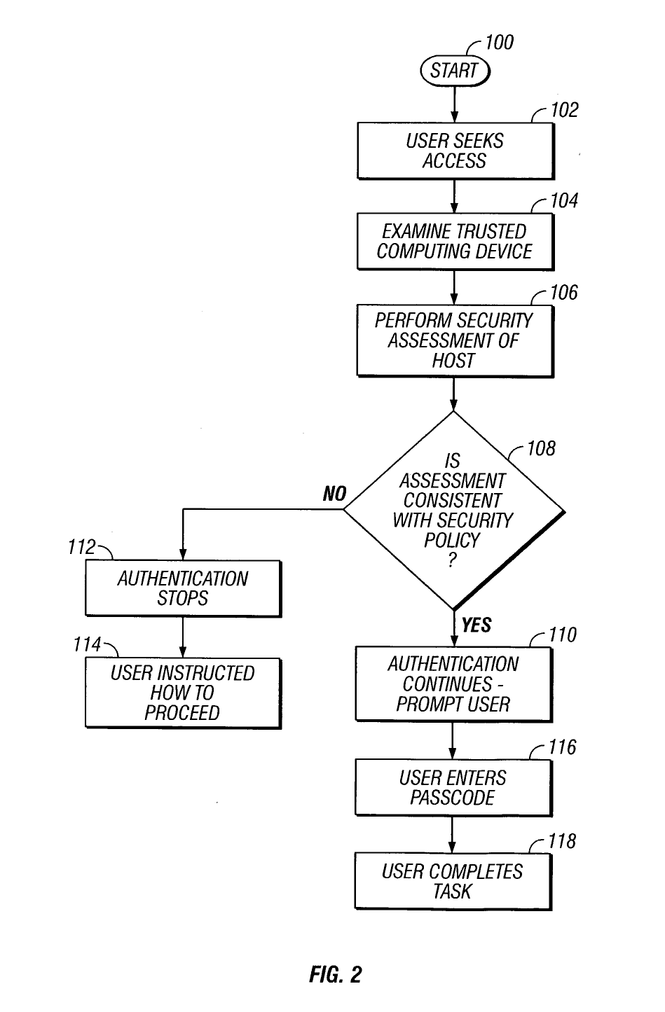

FIG. 2 is a flow diagram of a method for protecting secure credentials on an untrusted computer platform according to the invention. The invention comprises a technique that enforces the desired computer security policy at the point of user authentication. At the start of the method (100) a user seeks access to local or remote applications or services (102). The invention provides a method that begins by examining a trusted computing device (104), described above, and performing a security assessment (106) based on a pre-determined and configurable security policy stored on a trusted computing device. If the assessment of the host is consistent with the security policy (108) the user is permitted to continue the authentication process (110). If the assessment of the host fails to meet the security policy stored or evaluated on the trusted computing device (112), authentication is not allowed to proceed and the user is instructed on how to fix the problem or who to contact (114). Such instruction may be, for example, a warning that is displayed on the user's computer or a message may be generated and sent to the company security center, alerting the company of a breach of policy.

The security policy could include, for example, such things as:

Does the computer have anti-virus software actively running?

Is the anti-virus definition file up to date?

Are there are known viruses or potentially harmful applications currently running on this host?

Is there a password-protected screen saver configured to activate on the host in a specified duration of inactivity?

Such security policy can, as well, provide for anything else that the company decides is relevant to protect their intellectual property or information.

Thus, the invention is readily used to protect corporate assets and access to information within an enterprise or network, for example to protect an Internet service provider, where many users of different levels of technical skill and diligence access the system using disparate platforms, e.g. some of which are kept secure and well maintained, and some of which barely function and/or are publicly exposed.

As discussed above, the security policy elements are codified and stored in a protected portion of the trusted computing device, e.g. a smartcard, and updated frequently by a remote host maintained by the corporation or ISP. The trusted computing device also may contain the user's credentials that are used to authenticate the user to an application on the host or a remote system. The user must provide a passcode or PIN (116) to use the credentials stored on the trusted computing device. Applications that require these credentials must include or use a module that allows them to read or use these credentials. This module, as discussed above, intercepts authentication requests and performs the role of interpreting the security policy stored on the trusted computing device and performing the assessment. It does this before the user is allowed to enter their passcode to unlock the trusted computing device, thereby protecting the user from divulging their passcode to an unscrupulous application.

If the module determines that the host computer is in compliance with the security policy reflected on the trusted computing device the application is permitted to then prompt the user for their passcode. With the correct passcode provided, the application is then able to authenticate the user and the user is allowed to complete their desired task (118).

If the module determines that the host computer is not in compliance with one or more elements in the security policy it refuses to let the application prompt for the user's passcode, which denies the user access to their application. Such negative reinforcement helps to ensure that action is taken to secure the machine properly before putting the user's credentials or corporate information at risk.

While the use of personal firewalls and anti-virus software is not new, the fact that nothing actually checks to see if these elements are running before letting users use their machines is novel. The presently preferred embodiment of the invention is designed so that a compromised system fails in a safe way, meaning that it protects information at the expense of interfering with the user's task. If the system is compromised by a virus or Trojan horse and the authentication module is damaged or deleted, applications that require the use of credentials stored on the card cannot operate correctly. This reinforces the requirement that a security policy must be enforced.

The background art components required to implement the invention are familiar to those skilled in the art and are point solutions, such as personal firewalls, screen savers with passwords, and anti-virus software. The invention requires that a prudent mix of these existing elements be in use before the user can authenticate to their application or remote host. Because the invention is configurable, it helps the corporation or ISP adjust this security policy to adapt to ever-changing threats that hackers produce with regard to the computing environment.

The invention could also be applied to corporate security policy, as well as user security policy. Hackers frequently solicit company employees and system users for their screen name, password, and other secure information, such as a SecurID token code. The invention seriously impacts the hackers' ability to gather and use this information successfully. For example, if the user's credential is stored on the smartcard, e.g. an instantiation of a trusted computing device, and cannot be retrieved, e.g. is a digital certificate, then having access to the user's passcode does the hacker no good. Further, even if the user's computer is compromised by a hacker's Trojan horse and the hacker is monitoring the user's computer to steal the card's passcode, it does the hacker no good because the application module determines that the machine is infected. It does not, therefore, permit the user to run these applications and prohibits the user from typing their passcode.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for enforcing a computer security policy at a point of user authentication, comprising the steps of:
performing a security assessment based on a pre-determined and configurable security policy stored on a trusted computing device associated with a user computer;
if said assessment of said user computer is consistent with said security policy, permitting said user to continue said authentication process; and
if said assessment of said user computer fails to meet said security policy, not permitting said authentication to proceed.

2. The method of claim 1, further comprising the step of:
instructing said user on how to proceed if said assessment of said user computer fails to meet said security policy.

3. The method of claim 1, wherein said security assessment performed on said policy implements policy rules which may comprise detecting any of:
whether anti-virus software is running;
whether an anti-virus definition file is up to date;
whether there are known viruses or potentially harmful applications running on said user computer; and
whether a password-protected screen saver is configured to activate on said user computer in a specified duration of inactivity to prevent unauthorized system access during a user's absence from said user's computer.

4. The method of claim 1, wherein said security policy is codified and stored in a protected portion of said trusted computing device.

5. The method of claim 4, wherein said trusted computing device comprises a smartcard.

6. The method of claim 1, wherein said security policy is updated frequently by a remote host.

7. The method of claim 4, wherein said trusted computing device comprises a tamperproof device, possessed by said user, that incorporates a transmitter; wherein a user's proximity to said user computer is sufficient to establish requisite trust, based upon a secure conversation between said tamperproof device and said user computer; and wherein when the user is not near to said user computer, said secure conversation ceases, and said requisite trust is absent.

8. The method of claim 1, wherein said trusted computing device further comprises:
user credentials for authenticating said user to an application on either of said user computer and a remote system.

9. The method of claim 8, wherein said user must provide either of a passcode and a PIN to use said credentials.

10. The method of claim 8, further comprising:
a module for allowing applications to read or use said credentials.

11. The method of claim 10, wherein said module is adapted for connection to one of said user's computer ports.

12. The method of claim 10, wherein said module intercepts authentication requests, interprets said security policy, and performs said assessment before said user is allowed to enter a passcode to unlock said trusted computing device, wherein said user is protected from divulging said passcode to an unscrupulous application.

13. The method of claim 12, wherein if said module determines that said user computer is in compliance with said security policy reflected on said trusted computing device, said user is prompted for said passcode; and wherein if said module determines that said user computer is not in compliance said security policy, permission to prompt said user for said user's passcode is denied.

14. A method for enforcing a computer security policy at a point of user authentication, comprising the steps of:
performing a security assessment of a user computer based on a predetermined and configurable security policy stored on a trusted computing device;
if said assessment of said user computer is consistent with said security policy, permitting said user to continue said authentication;
if said assessment of said user computer fails to meet the security policy, not permitting said authentication to proceed; and
instructing said user on how to proceed.

15. The method of claim 14, wherein said security policy comprises a set of rules that test for any of:
whether said user computer has anti-virus software actively running;
whether an anti-virus definition file is up to date;
whether there are known viruses or potentially harmful applications currently running on said user computer; and
whether there is a password-protected screen saver configured to activate on said user computer in a specified duration of inactivity.

16. The method of claim 14, wherein said security policy is codified and stored in a protected portion of said trusted computing device.

17. An apparatus for enforcing a computer security policy at a point of user authentication, comprising:
a pre-determined and configurable security policy stored on a trusted computing device associated with said user computer;
a module associated with said user computer for performing a security assessment based on said pre-determined and configurable security policy stored on a trusted computing device associated with said user computer; and
a mechanism for permitting said user to continue said authentication process if said assessment of said user computer is consistent with said security policy and for not permitting said authentication to proceed if said assessment of said user computer fails to meet said security policy.

18. The apparatus of claim 17, further comprising:
a mechanism for instructing said user on how to proceed if said assessment of said user computer fails to meet said security policy.

19. The apparatus of claim 17, wherein said security assessment performed on said policy implements policy rules which may comprise detecting any of:
whether anti-virus software is running;
whether an anti-virus definition file is up to date;
whether there are known viruses or potentially harmful applications running on said user computer; and
whether a password-protected screen saver is configured to activate on said user computer in a specified duration of inactivity to prevent unauthorized system access during a user's absence from said user's computer.

20. The apparatus of claim 17, wherein said security policy is codified and stored in a protected portion of said trusted computing device.

21. The apparatus of claim 20, wherein said trusted computing device comprises a smartcard.

22. The apparatus of claim 17, wherein said security policy is updated frequently by a remote host.

23. The apparatus of claim 20, wherein said trusted computing device comprises a tamperproof device, possessed by said user, that incorporates a transmitter; wherein a user's proximity to said user computer is sufficient to establish requisite trust, based upon a secure conversation between said tamperproof device and said user computer; and wherein when the user is not near to said user computer, said secure conversation ceases, and said requisite trust is absent.

24. The apparatus of claim 17, wherein said trusted computing device further comprises:
user credentials for authenticating said user to an application on either of said user computer and a remote system.

25. The apparatus of claim 24, wherein said user must provide either of a passcode and a PIN to use said credentials.

26. The apparatus of claim 24, further comprising:
a module for allowing applications to read or use said credentials.

27. The apparatus of claim 26, wherein said module is adapted for connection to one of said user's computer ports.

28. The apparatus of claim 26, wherein said module intercepts authentication requests, interprets said security policy, and performs said assessment before said user is allowed to enter a passcode to unlock said trusted computing device, wherein said user is protected from divulging said passcode to an unscrupulous application.

29. The apparatus of claim 28, wherein if said module determines that said user computer is in compliance with said security policy reflected on said trusted computing device, said user is prompted for said passcode; and wherein if said module determines that said user computer is not in compliance said security policy, permission to prompt said user for said user's passcode is denied.

30. An apparatus for enforcing a computer security policy at a point of user authentication, comprising:
a module for performing a security assessment of a user computer based on a pre-determined and configurable security policy stored on a trusted computing device;
a module for permitting said user to continue said authentication if said assessment of said user computer is consistent with said security policy and not permitting said authentication to proceed if said assessment of said user computer fails to meet the security policy; and
a module for instructing said user on how to proceed.

31. The apparatus of claim 30, wherein said security policy comprises a set of rules that test for any of:
whether said user computer has anti-virus software actively running;
whether an anti-virus definition file is up to date;
whether there are known viruses or potentially harmful applications currently running on said user computer; and
whether there is a password-protected screen saver configured to activate on said user computer in a specified duration of inactivity.

32. The apparatus of claim 30, wherein said security policy is codified and stored in a protected portion of said trusted computing device.

33. An apparatus for enforcing a computer security policy at a point of user authentication, comprising:
a pre-determined and configurable security policy stored on a trusted computing device associated with said user computer.

34. An apparatus for enforcing a computer security policy at a point of user authentication, comprising:
a module associated with a user computer for performing a security assessment based on a pre-determined and configurable security policy stored on a trusted computing device associated with said user computer, wherein said module intercepts authentication requests, interprets said security policy, and performs said assessment before said user is allowed to enter a passcode to unlock said trusted computing device, wherein said user is protected from divulging said passcode to an unscrupulous application, wherein if said module determines that said user computer is in compliance with said security policy reflected on said trusted computing device, said user is prompted for said passcode; and wherein if said module determines that said user computer is not in compliance said security policy, permission to prompt said user for said user's passcode is denied.

35. An apparatus for enforcing a computer security policy at a point of user authentication, comprising:
a mechanism for permitting a user to continue said authentication if an assessment of a user computer is consistent with a security policy and for not permitting said authentication to proceed if said assessment of said user computer fails to meet said security policy.

36. The apparatus of claim 35, further comprising:
user credentials for authenticating said user to an application on either of said user computer and a remote system, wherein said user must provide either of a passcode and a PIN to use said credentials.
